(19) United States
(12) Patent Application Publication
(10) Pub. No.: US 2012/0143491 A1
(43) Pub. Date: Jun. 7, 2012

(54) METHOD FOR PROVIDING A NAVIGATION ROUTE ACCORDING TO A POINT OF INTEREST ON THE NAVIGATION ROUTE AND DEVICE THEREOF

(76) Inventor: Ying-Tz Cheng, Taipei City (TW)

(21) Appl. No.: 13/304,267

(22) Filed: Nov. 23, 2011

(30) Foreign Application Priority Data
Dec. 6, 2010 (TW) 099142422

(51) Int. Cl. G01C 21/34

(52) U.S. Cl. 701/410; 701/408

(57) ABSTRACT

A method for providing a navigation route according to a point of interest on the navigation route includes determining a current position and a destination, utilizing a personal navigation device to generate a plurality of navigation routes from the current position to the destination, calculating the weightings of the plurality of navigation routes and providing a navigation route according to the weightings of the plurality of navigation routes. If a predetermined point of interest is located on a first navigation route of the plurality of navigation routes, the personal navigation device adjusts the weighting of the first navigation route.

### BACKGROUND OF THE INVENTION

1. Field of the Invention

The present invention is related to a method for providing a navigation route, and more particularly, to a method for providing a navigation route according to a point of interest on the navigation route.

2. Description of the Prior Art

GPS (Global Positioning System) is a space-based global navigation satellite system which provides reliable location and time information in all weather, at all times, and almost anywhere on or near the Earth. GPS-based personal navigation devices are well known and widely employed as in-car navigation devices. Common functions of a personal navigation device include providing a map database for generating navigation instructions which are then shown on a display of the personal navigation device. In order to enable a user to navigate to a pre-defined destination from a start point, a personal navigation device may have an internal system (such as a GPS receiver) for receiving location data, or may merely be connectable to a receiver which can receive location data. The personal navigation device may compute a route itself, or communicate with a remote server which is configured to compute the route and provides navigation information to the personal navigation device, or a hybrid device in which the personal navigation device itself and a remote server both play a role in the route computation process. These personal navigation devices are often mounted on or in the dashboard of a vehicle using a suction mount or other mounting means, and may thus readily be dismounted. Generally (but not necessarily), personal navigation devices are fully self-contained, such as including an internal GPS antenna, navigation software and map database, and can hence plot and display a route to be taken.

In map database and navigation software of a conventional personal navigation device (PND), different roads correspond to different level of a predetermined road hierarchy. The conventional personal navigation device assigns different weighting for roads with different levels of the predetermined road hierarchy, for computing a navigation route according to user requirements or configurations. However, although the conventional navigation device is able to compute a navigation route from one departing point to a destination, the conventional navigation device is unable to compute a route that deliberately passes a specific point of interest (POI) without detouring from the navigation route.

### SUMMARY OF THE INVENTION

The present invention discloses a method for providing a navigation route according to a point of interest on the navigation route. The method comprises determining a current location and a destination; utilizing a personal navigation device to compute a plurality of navigation routes from the current location to the destination; calculating weightings of the plurality of navigation routes according to points of interest on the plurality of navigation routes; and providing the navigation route with a highest weighting for navigating a user to travel from the current location to the destination.

The present invention further discloses a method for providing a navigation route according to points of interest on navigation routes. The method comprises determining a current location and a destination; utilizing a personal navigation device to compute a plurality of navigation routes from the current location to the destination; calculating weightings of the plurality of navigation routes according to points of interest on the plurality of navigation routes and road hierarchy levels of the plurality of navigation routes; and providing the navigation route with a highest weighting for navigating a user to travel from the current location to the destination.

The present invention further discloses a personal navigation device for providing a navigation route according to points of interest on navigation routes. The personal navigation device comprises a case, a monitor, a GPS receiver, a memory and a processor. The monitor is disposed on the case. The GPS receiver is disposed in the case, for receiving a current location of the personal navigation device. The memory is disposed in the case, for storing a map database and navigation software. The processor is disposed in the case, for executing the navigation software to compute a plurality of navigation routes according to the current location, a destination and the map database, and calculating weightings of the plurality of navigation routes for providing a navigation route with a highest weighting to navigate a user from the current location to the destination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a method of the present invention for providing a navigation route according to a point of interest (POI) on the navigation route.

FIG. 2 is a diagram illustrating the method of the present invention adjusting weightings of the navigation routes according to POIs on the navigation routes.

FIG. 3 is a diagram illustrating the method of the present invention adjusting weightings of the navigation routes according to different POIs on the navigation routes.

FIG. 4 is a diagram illustrating a personal navigation device for providing a navigation route according to POIs on the navigation routes computed.

### DETAILED DESCRIPTION

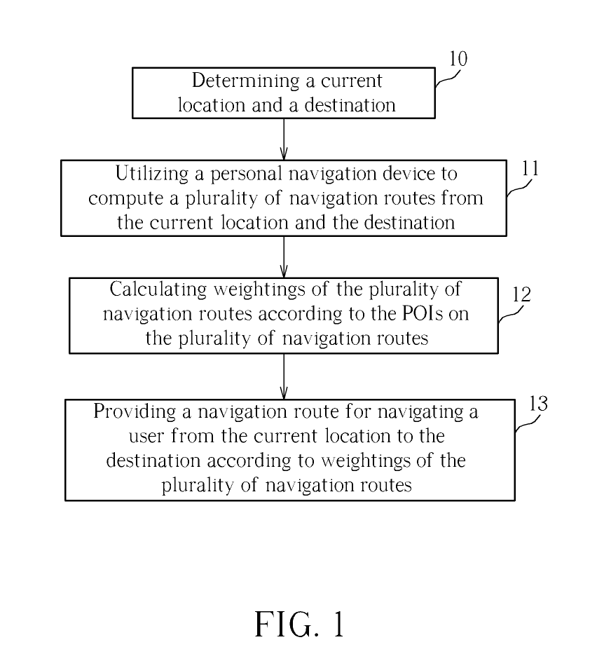

Please refer to FIG. 1. FIG. 1 is a diagram illustrating a method of the present invention for providing a navigation route according to a point of interest (POI) on the navigation route. Steps of the method include:

Step 10: determining a current location and a destination;

Step 11: utilizing a personal navigation device to compute a plurality of navigation routes from the current location and the destination;

Step 12: calculating weightings of the plurality of navigation routes according to the POIs on the plurality of navigation routes; and

Step 13: providing a navigation route for navigating a user from the current location to the destination according to weightings of the plurality of navigation routes.

In the method of the present invention, the personal navigation device computes a plurality of navigation routes from a current location to a destination first, according to a default algorithm of the personal navigation device. The personal navigation device calculates weightings of the plurality of navigation routes according to POIs on the plurality of navigation routes. For instance, if one predetermined POI is located on a first navigation route of the plurality of navigation routes, the personal navigation device adjusts weighting of the first navigation route.

Each of the different predetermined POIs is assigned with a score respectively, which reflect the impact each POI has on the weightings of the navigation routes computed by the personal navigation device. The method of the present invention calculates or adjusts weightings of the plurality of navigation routes according to scores of the POIs on the plurality of navigation routes. The personal navigation device then selects one route out of the plurality of navigation routes according to weightings of the plurality of navigation routes, so as to navigate the user from the current location to the destination. For instance, the personal navigation device can select a navigation route with a highest weighting (or a navigation route with a lowest weighting or a medium weighting, etc.) out of the plurality of navigation routes computed for navigating the user. Since the personal navigation device has computed a plurality of navigation routes according to the default algorithm first, and then adjusts weightings of the computed navigation routes in which the predetermined POIs are located, the user will not feel detoured when the method of the present invention is utilized to navigate the user to pass the predetermined POI on the navigation route.

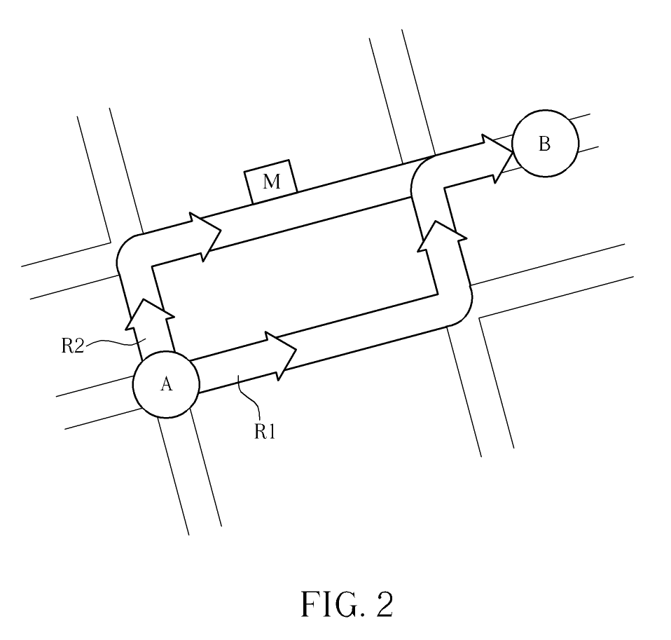

Please refer to FIG. 2. FIG. 2 is a diagram illustrating the method of the present invention adjusting weightings of the navigation routes according to POIs on the navigation routes. As illustrated in FIG. 2, when the user plans to go from a departing point A to a destination B, the personal navigation device computes navigation routes R1 and R2 according to the default algorithm. Assume a predetermined POI M, such as McDonalds, is stored in the personal navigation device. When the personal navigation device determines a McDonalds is located on the navigation route R2, the personal navigation device adjusts weighting of the navigation route R2, so the navigation route R2 can be selected by the personal navigation device to navigate the user from the departing point A to the destination B, and the user passes the predetermined POI (e.g. McDonalds) while traveling along the navigation route R2.

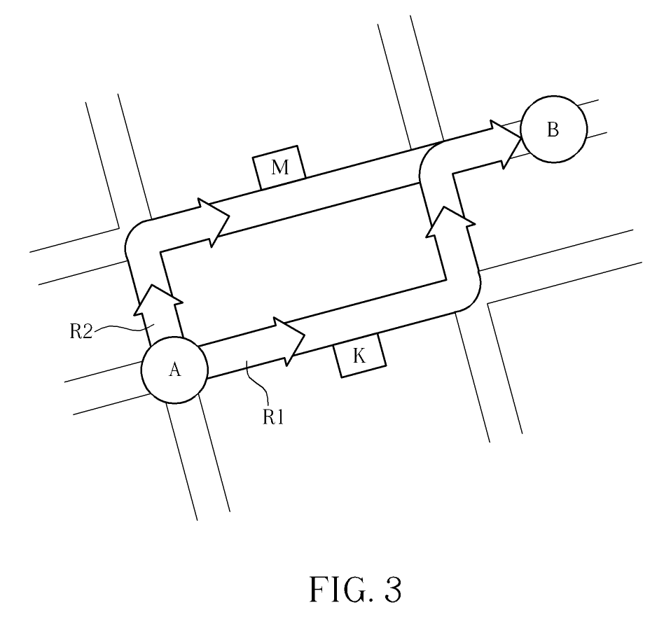

Navigation routes computed by the method of the present invention can comprise a plurality of different predetermined POIs. The personal navigation device can adjust weightings of the navigation routes in which different predetermined POIs are located with different magnitudes, according to different predetermined POIs. Please refer to FIG. 3. FIG. 3 is a diagram illustrating the method of the present invention adjusting weightings of the navigation routes according to different POIs on the navigation routes. Assume two predetermined POIs M and K are stored in the personal navigation device. For instance, the predetermined POI M is McDonalds and the predetermined POI K is Kentucky Fried Chicken (KFC).

The personal navigation device adjusts weightings of navigation routes in which the predetermined POIs M and K are located with different magnitudes. For instance, the personal navigation device adds “7” units to the weighting of the navigation route in which the predetermined POI M is located, and adds “5” units to the weighting of the navigation route in which the predetermined POI K is located. As illustrated in FIG. 3, when the user plans to go from a departing point A to a destination B, the personal navigation device computes navigation routes R1 and R2 according to the default algorithm.

When the personal navigation device determines a KFC (e.g. the predetermined POI K) is located on the navigation route R1, and a McDonalds (e.g. the predetermined POI M) is located on the navigation route R2 at the same time, the personal navigation device adjusts weightings of the navigation routes R1 and R2 respectively. For instance, the personal navigation device increases the weighting of the navigation route R1 in which the KFC (e.g. the predetermined POI K) is located by “5” units and increases the weighting of the navigation route R2 in which the McDonalds (e.g. the predetermined POI M) is located by “7” units. In the present embodiment, the personal navigation device selects a navigation route with the highest weighting from the plurality of navigation routes computed to navigate the user. Since the weighting of the navigation route R1 is increased by “5” units and the weighting of the navigation route R2 is increased by “7” units, the personal navigation device selects the navigation route R2 for navigating the user to travel from the departing point A to the destination B, and the user will pass the POI M which is McDonalds along the navigation route R2.

In another embodiment of the present invention, the personal navigation device can also calculate weightings of the plurality of navigation routes according to POIs on the plurality of navigation routes computed and levels of a predetermined road hierarchy of the plurality of navigation routes. In navigation software and a map database of the personal navigation device, different roads are configured to correspond to different levels of the road hierarchy by default. The road hierarchy categorizes roads according to their traveling efficiencies, functions and capacities, etc. For instance, freeways, express ways, elevated roadways, provincial highways, county routes and country roads, etc. correspond to different levels of the road hierarchy respectively. Generally, the freeways provide mostly uninterrupted travel (e.g. high travelling efficiency), hence at the top of the road hierarchy. When computing navigation routes, the personal navigation device can select roads at a higher level of the road hierarchy to assist the user to reach the destination more efficiently.

If the personal navigation device calculates or adjusts weightings of the navigation routes solely accordingly to scores of the predetermined POIs on the navigation routes, and then selects one route with the highest weighting in the plurality of navigation routes, the navigation route with the highest weighting may comprise a plurality of predetermined POIs but at a lower level of the road hierarchy (e.g. low traveling efficiency). Therefore, for refining routes computed to be more efficient and practical, in the method of the present invention, the personal navigation device computes a plurality of navigation routes according to the default algorithm, then adjusts weightings of the plurality of navigation routes according to “whether the plurality of navigation routes comprise predetermined POIs” and “levels of the road hierarchy the navigation routes correspond to”, and then selects one navigation route with the highest weighting to navigate the user. In such a way, the method of the present invention can navigate the user from the current location to the destination along the navigation route that passes the predetermined POI, without lowering traveling efficiency.

In the embodiment illustrated by FIG. 3, the personal navigation device adds “7” units to the weighting of the navigation route in which the predetermined POI M is located, and adds “5” units to the weighting of the navigation route in which the predetermined POI K is located. Further, assuming a level of the road hierarchy associated with the navigation route R1 is “9” and a level of the road hierarchy associated with the navigation route R2 is “3”. A ratio of how the predetermined POI and the road hierarchy level affect the weighting of the navigation route is 50% to 50%. Hence, according to the predetermined POI K and the road hierarchy level associated with the navigation route R1, the personal navigation device adds (5*0.5+9*0.5=7) units to the weighting of the navigation route R1. According to the predetermined POI M and the road hierarchy level associated with the navigation route R2, the personal navigation device adds (7*0.5+3*0.5=5) units to the weighting of the navigation route R2. In such a way, even if the score of the POI M is higher than that of the POI K, the personal navigation device still provides the navigation route R1 in which the POI K is located to the user when taking road hierarchy levels of the routes R1 and R2 into consideration.

In another embodiment of the present invention, the ratio of how the predetermined POI and the road hierarchy level affect the weighting of the navigation route can be adjusted. Taking the setting illustrated in FIG. 3 as an example, assume the ratio of how the predetermined POI and the road hierarchy level affect the weighting of the navigation route is 80% to 20%. In this case, the personal navigation device adds (5*0.8+9*0.2=5.8) units to the weighting of the navigation route R1, and the personal navigation device adds (7*0.8+3*0.2=6.2) units to the weighting of the navigation route R2. In this case, the personal navigation device provides the navigation route R2 in which the POI M is located to the user.

The affect the predetermined POIs (e.g. POIs M and K) have on weightings of the navigation routes computed by the personal navigation device is preset in the personal navigation device, but is not limited to this. In another embodiment of the present invention, the user can specify the predetermined POIs and also configure the degree of each different POI (e.g. the score of each POI) affecting weightings of the navigation routes computed by the personal navigation device.

In yet another embodiment of the present invention, the personal navigation device can calculate/adjust weightings of the navigation routes computed according to categories of the predetermined POIs located on the navigation routes computed. The score of each POI can be configured according to a desired category. For instance, if a user selects a category of predetermined POIs to be “restaurant”, weightings of all POIs that belong to the “restaurant” category on the plurality of routes computed by the personal navigation device are adjusted, e.g. increased. The personal navigation device can then select a navigation route with the highest weighting, so the user passes more POIs in the “restaurants” category along the route provided by the personal navigation device.

In another embodiment of the present invention, if a user selects a category of predetermined POIs to be “restaurant”, the personal navigation device can simply count a number of POIs that belong to the “restaurant” category on the plurality of routes computed by the personal navigation device and selects a navigation route with the most POIs that belong to the “restaurant” category, for the user to pass more POIs in the selected “restaurants” category along the route provided by the personal navigation device. The predetermined POIs can be categorized into stores, shopping malls, hostels, entertainment facilities, banks, automobile garages, restaurants and/or commercial stands, etc, but are not limited to these.

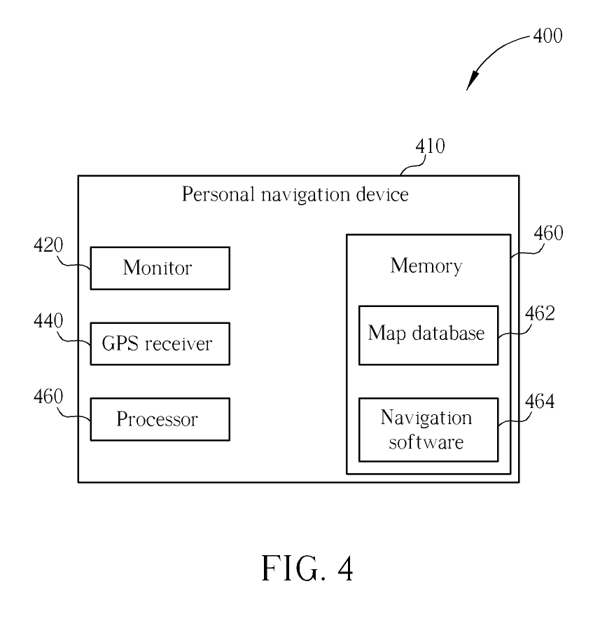

Please refer to FIG. 4. FIG. 4 is a diagram illustrating a personal navigation device 400 for providing a navigation route according to POIs on the navigation routes computed. The personal navigation device 400 comprises a case 410, a monitor 420, a GPS receiver 440, a memory 460 and a processor 480. The monitor 420 is disposed on the case 410 of the personal navigation device 400, and the memory 460 and the processor 480 are disposed in the case 410 of the personal navigation device 400. The GPS receiver 440 is for receiving a current location of the personal navigation device 400. The memory 460 stores a map database 462 and navigation software 464. The processor 480 is for executing the navigation software 464 so as to compute a plurality of navigation routes according to a current location (or a departing point) of the personal navigation device 400, a destination and the map database 462. The processor 480 also calculates weightings of the plurality of navigation routes according to whether predetermined POIs are located on the plurality of navigation routes, for providing a navigation route with the highest weighting to navigate the user from the current location (or a departing point) of the personal navigation device 400 to the destination. The memory 460 stores at least one predetermined POI. The algorithm the personal navigation device 400 utilizes to adjust weightings of navigation routes in which different predetermined POIs are located can also be stored in the memory 460. The processor 480 can calculate/adjust weightings of the plurality of navigation routes according to effect each different predetermined POI has on the weightings of the navigation routes (e.g. the score of each predetermined POI) computed by the personal navigation device. In another embodiment of the present invention, the processor 480 can calculate weightings of the plurality of navigation routes according to scores of POIs located on the navigation routes computed and road hierarchy levels of the navigation routes.

In summary, the present invention discloses a method for providing a navigation route according to POIs located on the navigation route. The method of the present invention computes a plurality of navigation routes according to the default algorithm of a personal navigation device, and then adjusts weightings of navigation routes in which predetermined POIs are located. In such a way, the present invention can navigate the user through routes with specific POIs, such as routes with commercial/advertising benefits, without detouring the user or causing the user to take a further route. Further, the present invention can provide a placement marketing service to products corresponding to the predetermined POIs, for increasing the exposure and the purchasing appeal of products corresponding to the predetermined POIs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for providing a navigation route according to a point of interest on the navigation route, the method comprising:
determining a current location and a destination;
utilizing a personal navigation device to compute a plurality of navigation routes from the current location to the destination;
calculating weightings of the plurality of navigation routes according to points of interest on the plurality of navigation routes; and
providing the navigation route with a highest weighting for navigating a user to travel from the current location to the destination.

2. The method of claim 1, further comprising storing at least one point of interest in the personal navigation device, each point of interest is assigned with a score.

3. The method of claim 2, further comprising assigning a score to each of the points of interest, wherein the method calculates the weightings of the plurality of navigation routes according to the score of each point of interest on the plurality of navigation routes.

4. The method of claim 3, wherein the score of each point of interest can be configured by the user.

5. The method of claim 3, wherein the score of each point of interest can be configured according to a category of each point of interest.

6. The method of claim 5, wherein the score of each point of interest is increased when the category of each point of interest belongs to a selected category.

7. The method of claim 5, further comprising providing the navigation route with most points of interest that belong to the selected category.

8. The method of claim 5, wherein the category of each point of interest comprises stores, shopping malls, hostels, entertainment facilities, banks, automobile garages, restaurants and/or commercial stands.

9. A method for providing a navigation route according to points of interest on navigation routes, the method comprising:
determining a current location and a destination;
utilizing a personal navigation device to compute a plurality of navigation routes from the current location to the destination;
calculating weightings of the plurality of navigation routes according to points of interest on the plurality of navigation routes and road hierarchy levels of the plurality of navigation routes; and
providing the navigation route with a highest weighting for navigating a user to travel from the current location to the destination.

10. The method of claim 9, further comprising storing at least one point of interest in the personal navigation device, wherein each point of interest is assigned with a score.

11. The method of claim 10, further comprising assigning a score to each of the points of interest, wherein the method calculates the weightings of the plurality of navigation routes according to the score of each point of interest on the plurality of navigation routes and the road hierarchy levels of the plurality of navigation routes.

12. The method of claim 11, wherein the score of each point of interest can be configured by the user.

13. The method of claim 11, wherein the score of each point of interest can be configured according to a category of each point of interest.

14. The method of claim 10, wherein a category of each point of interest comprises stores, shopping malls, hostels, entertainment facilities, banks, automobile garages, restaurants and/or commercial stands.

15. The method of claim 9, wherein a ratio of how the points of interest and the road hierarchy levels affect the weightings of the plurality of navigation routes can be adjusted.

16. A personal navigation device for providing a navigation route according to points of interest on navigation routes, comprising:
a case;
a monitor, disposed on the case;
a GPS receiver, disposed in the case, for receiving a current location of the personal navigation device;
a memory, disposed in the case, for storing a map database and navigation software; and
a processor, disposed in the case, for executing the navigation software to compute a plurality of navigation routes according to the current location, a destination and the map database, and calculating weightings of the plurality of navigation routes for providing a navigation route with a highest weighting to navigate a user from the current location to the destination.

17. The personal navigation device of claim 16, wherein the memory stores at least one point of interest, and each point of interest is assigned with a score.

18. The personal navigation device of claim 17, wherein the processor calculates the weightings of the plurality of navigation routes according to the score of each point of interest on the plurality of navigation routes.

19. The personal navigation device of claim 17, wherein the processor calculates the weightings of the plurality of navigation routes according to the score of each point of interest on the plurality of navigation routes and road hierarchy levels of the plurality of navigation routes.

20. The method of claim 17, wherein a category of each point of interest comprises stores, shopping malls, hostels, entertainment facilities, banks, automobile garages, restaurants and/or commercial stands.
